(19) United States
(12) Patent Application Publication
(10) Pub. No.: US 2011/0055053 A1
(43) Pub. Date: Mar. 3, 2011

(54) Computerized method of identifying best fitting footwear

(75) Inventor: Dirk Rutschmann, Stuttgart (DE)

(73) Assignee: corpus.e AG, Stuttgart (DE)

(21) Appl. No.: 12/584,222

(22) Filed: Sep. 2, 2009

(51) Int. Cl. G06Q 30/00; G06Q 50/00; G06Q 10/00; G06N 5/02; G06Q 99/00; G06F 17/50; G06F 17/30

(52) U.S. Cl. 705/27.2; 705/28; 706/54; 703/1; 707/E17.014; 707/E17.044; 705/1.1

(57) ABSTRACT

A method of identifying footwear which best fits a customer's feet, includes the steps of digitizing the feet of a customer needing footwear with a 3D foot scanner and generating a numerical 3D model of the customer's feet, comparing, with a computer-based matching engine, the information of the 3D feet model with the content of a database containing numerical 3D models of the interior shoe shape of footwear available to be sold, producing a list of one or more best-fit footwear candidates to the customer and/or to the staff of a footwear shop and concluding the purchasing process or, respectively, aborting it in case of insufficient best fit footwear being found in the footwear stock available for selling.

### FIELD OF INVENTION

This invention relates to a method for a fully or partially automated selection of footwear which fits best to the feet of a customer. In particular it describes a novel real or virtual (i.e. internet-based) footwear selling business based on the optimal match of 3D scans of the customer's feet with a library of 3D scans of the inner void shape of mass-produced footwear.

### BACKGROUND OF THE INVENTION

Finding a best-fitting footwear for an individual foot or for a pair of feet of a customer still is a major problem in any shoe-shop, be it a real physical shop or a virtual internet-based shop.

Even when the approximate foot measures (expressed f.i. in standard Brannock measures) might be available both for the customer feet and for the footwear in stock, the selection process still relies mainly on the expertise of the shop selling staff and the correctly judged try-on of a number of possible footwear candidates by the customer.

Many (physical) shoe selling shops today do suffer from a poor footwear-related expertise of their staff. The staff is often no longer sufficiently expert neither in foot anatomy nor in the subtle differences of different brands produced by the many national and international footwear producers and more then often not being correctly and uniquely specified by standard size measures such as the Brannock foot sizing system.

Many internet-based shops failed completely or suffer from a high number of returns due to the missing “try-on and walk-around in the shop” procedure which still gives by far the best results in buying good fitting footwear, be it casual, sports or specialised footwear.

Many attempts have been undertaken to use optical 3D foot scanner and 3D last models to find the best-fitting shoes for a given customer (see f.i the Infoot® 3D footscanner and the Shoemaster last design and matching software, (www.shoemaster.co.uk). Whereas this approach works reasonably well for full customized shoes, i.e. for shoes produced with an individual last derived from the foot 3D scans, it largely fails when applied to the problem of a best-fit selection. We understand by “best-fit selection” the strategy to select, from a stock of physically existing shoes the particular product which fits best in terms of comfort, anatomy and additional constraints such as price, preferred brand etc. to the specific feet of a footwear buying customer.

This known approach to match 3D scans of the customer's feet to digital 3D models of the lasts used for producing footwear suffers from several methodical weaknesses:

a) the shape of a shoe last is by principle different from the anatomical shape of a foot. The last is designed to be used as a production tool, able to withstand the forces when stretching leather over it and stitching, gluing or welding the different pieces together; its shape is designed not to reflect 1:1 the foot, but thus that it is a production tool, allowing f.i. to easily be pulled out from the finished shoe due to a slim elliptic ankle. The last furthermore does not in general describe the shape of the foot bed.

b) the physical or digital last models are not readily available in a (physical or virtual) shoe shop. The last is considered to be the intellectual property (IP) of the shoe producer or the last designer and is therefore often kept as confidential. 3D scans of lasts usually cannot be produced without the approval of owner of the last, leading otherwise to a conflict with the IP rights.

A (real or virtual) footwear business providing a reliable and economical best-fit selection of existing footwear based on the customer's specific feet which does not require costly expertise of the selling staff and which minimizes the number of try-on is hence currently not available with the required quality.

### SUMMARY OF THE INVENTION

The fundamental idea of the present invention is to simplify and enhance the quality and the productivity of the business of footwear purchase as well for the buyer as for the seller. The invention describes a novel best-fit business for footwear; it is based on the computerized matching of 3D scans of the customer's feet to a database of 3D scans of the inner (void) shape of produced footwear, named in this text as the “ISS” model (“Interior Shape of Shoe” model).

Optical 3D scanners for recovering the external 3D shape of feet as required by the invention are state-of-the art and produced and marketed by different companies such as:

a) corpus.e AG, Stuttgart, Germany: the Lightbeam® foot scanner (www.corpus-e.com)

b) Vorum Research Corporation, Vancouver, Canada: the CANFIT-PLUS™ Yeti™ 3D Foot Scanner (www.vorum.com)

c) CSM3D International Limited, Bristol, UK: the Shoemaster INFOOT® 3D footscanner (www.shoemaster.co.uk)

The technology of optical scanners able to digitize the interior shape of shoes (in short: ISS) has been described recently in the US 2005/0168756 A1 and the WO 2009/006989 A1, both from corpus.e AG, Stuttgart, and is therefore known to the expert in the field as well.

These ISS scanners produce a high density digital 3D model of the boundaries of the inner void space of a shoe, including the upper part, the heel and toe regions and the sole bed.

The new idea of the invention is to build a footwear business which uses the interior shape of already manufactured shoes to be matched to the 3D model of the customer feet by a computer-based process to eliminate the major drawbacks of the current foot-to-last matching approach:

a) the 3D shape of the interior space of a given manufactured shoe fits far better to the anatomy of a customer's foot then the 3D shape of a production last of that shoe. Extensive research by corpus.e AG, Stuttgart, has confirmed this finding.

b) the ISS scan produces a complete 3D model of the inner shape which may include a specific foot bed. This is a dedicated advantage when matching a “multi-sensorial” 3D foot model (i.e. a combined digital model comprising both the geometric foot shape and the sole pressure distribution) to a series of candidate shoes which have an anatomical foot bed.

c) the scanning of the interior shape of a produced shoe for the purpose of a best-fit selection does not conflict with any IP rights attached to the last. No last must leave the producers plant; illegal copying of lasts for counterfeiting protected brands is thus prevented.

d) the interior shoe shape scanning can be restricted to a few sizes of a specific shoe model, typically to 3 to 4 sizes for a collection of typical 10 Brannock sizes. Intermediate interior shape models can be generated through interpolation from the scanned ones making the building-up of an ISS database rather fast.

e) building up a database with interior shoe shapes can as well be local (performed by the shoe shop) or centralized (performed by an organisation which supplies the ISS database content to different footwear stores), allowing an interesting variety of business models according to the invention.

### BRIEF DESCRIPTION OF THE DRAWINGS

The business model is explained in a exemplary way for the case of a real, physically existing shoe shop using 3D scanners for generating a 3D shape model of the customer's feet and using a matching engine connected to a digital database containing interior shoe shape (ISS) models for specifying one or several shoe models (by producer, model and size) best-fitting to the customer requirements.

FIG. 1 describes in a flow-chart the actions of a customer entering a footwear shop (1) having his feet scanned with a 3D foot scanner (3) to produce a digital 3D model (2) of the feet, a database (4) which contains digital models of the interior shoe shapes (ISS) of already produced and commercially available shoes which have been scanned with a 3D ISS scanner (5) and a best-fit matching engine (6) which compares the 3D model of the customer's feet (2) to the potentially interesting ISS models in the database (4) and issues a best-fit proposal (7) naming one or more shoe models (8) in stock or otherwise available which match with a sufficient degree the customer's anatomy so that the customer can leave the shop with a footwear best-fitting to his feet (9), the whole process running reliably and largely independent from an otherwise required expert knowledge of the selling staff and from the quite often ambiguous judgment of the customer himself when forced to try and judge the fit on a substantial number of shoe candidates in a short time in a shop.

FIG. 2 describes in a flow-chart the actions of a customer entering a footwear shop (1) having his feet scanned with a 3D foot scanner (3) to produce a digital 3D model (2) of the feet, a database (4) which contains digital models of the interior shoe shapes (ISS) of already produced and commercially available shoes which have been scanned with a 3D ISS scanner (5) and a best-fit matching engine (6) which accepts additional constraints (10) of the customer such as preferred price, style, material, footwear usage, anatomic specificities such a body weight and possible left-right foot imbalance etc. and compares the 3D model of the customer's feet (2) to the potentially interesting ISS models in the database (4) to issue a best-fit proposal naming one or more models which match with a sufficient degree both the customer's anatomy and the additional constraints.

### DETAILED DESCRIPTION OF THE INVENTION

The fundamental idea of the present invention is to simplify and enhance the quality and the productivity of the business of footwear purchase as well for the buyer as for the seller.

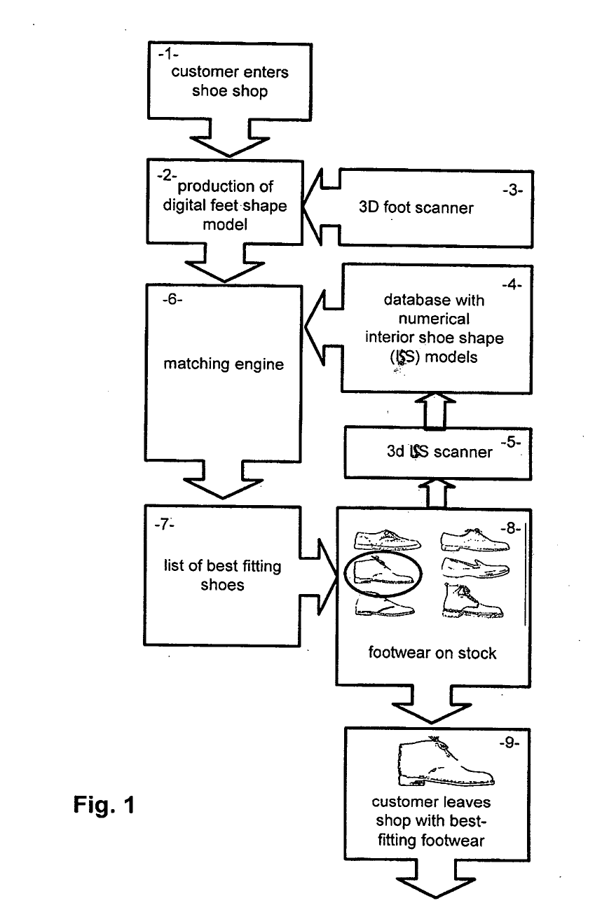

Referring to drawing FIG. 1, the customer (1) entering a shoe shop and looking for a pair of best-fitting footwear gets its feet individually scanned using an optical 3D foot scanner (2). Such foot scanners as listed above generally operate with optical triangulation or photogrammetrical methods and are becoming more and more common and easy to operate even by the non-expert shoe shop staff. They generate quite precise and dense digital 3D models (2) describing the shape of the foot either as a coordinate point cloud, as a triangulated or surfaced 3D model or additionally as a list of Brannock-type measures such as length, girth width and circumference, medial axis angle etc. which are automatically extracted from the digital 3D foot model.

It is a particular idea of the invention that the scanning of both feet individually produces two distinct 3D models, one for the right and one for the left foot. This allows to take into account a quite common anatomic situation, that a customer's feet differ by more then a half Brannock size and that the later best fit selection finds best fitting shoes through an individual match of the left foot 3D model and the right foot 3D model with a database of ISS (interior shoe shape models).

It is a particular idea of the invention to use a “multi-sensorial” foot scanner, i.e., a foot scanner which combines optical scanning of the foot shape with a pressure map scanning of the foot sole, and thus generates geometric shape information not only for the upper part of the foot but also anatomical information for a good foot bed. U.S. Pat. No. 7,489,812 B2 assigned to corpus.e AG, Stuttgart, describes such a photogrammetrical foot scanner incorporating additional physical sensors such as sole pressure map measuring devices.

The fundamental difference of the present invention from the existing state-of-the-art is that the business of finding a best fitting footwear, i.e., a footwear product from a specific producer or brand, with a specific model, for a specific use (elegant, casual, sports, leisure, etc.) and with a specific size is not achieved by the traditional matching of the customer's 3D foot model through a computer-based matching to a database of digital lasts, but (see FIG. 1) by matching with a software-based matching engine (6) the customer's 3D foot model (2) to a database (4) containing 3D models of the inner shape of shoes (ISS models) (5) available in the store or ready to be ordered from a producer or distributor. The matching engine (6) produces through a computerized matching of the information contained in the customer foot model (6) with the ISS database (4) a list of best matches which is displayed to the shop staff and to the customer.

The customer and the selling staff are thus informed in a very short time of a few seconds only about the single best fitting shoe product or about a small number of best fitting shoe candidates in an objective and scientifically sound way. The cumbersome try-on procedure can thus be drastically reduced to the very few shoe best-fitting product candidates. The invention thus speeds up and enhances greatly the quality of shoe candidate selection which traditionally was very much depending on the skill of the staff.

It is a particular idea of the invention that the matching engine also produces information about a possible need for a customized orthopaedic shoe, as none of the footwear products stored in the ISS database sufficiently matches with the customer 3D anatomy or have pronounced automatically identifiable deviations from good-health feet.

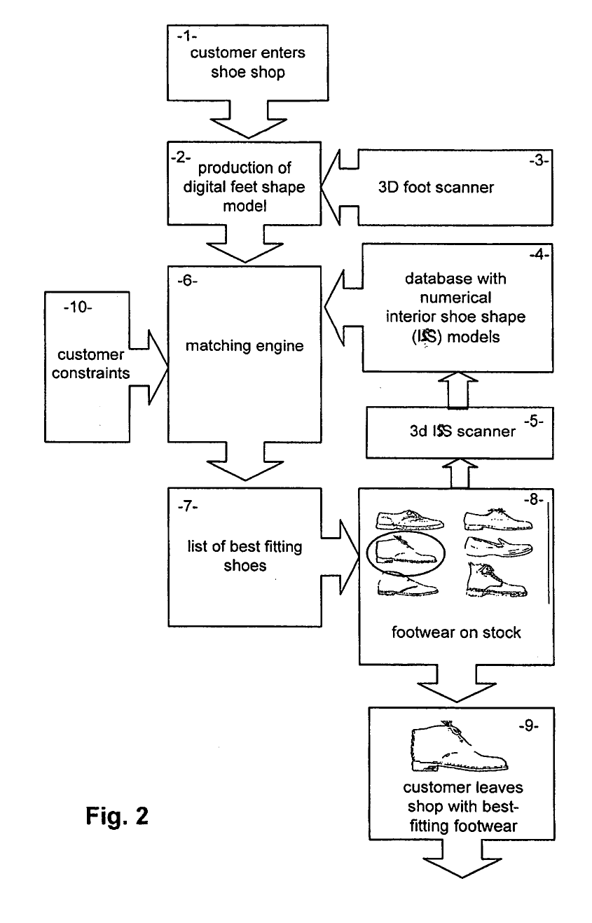

As depicted in the flowchart FIG. 2, it is a particular idea of the invention to combine the 3D feet shape data (3) with additional constraints (10) of the customer such as a preferred price range, style, material, footwear usage, anatomic specificities such a body weight and possible left-right foot imbalance, foot bed requirements, etc. and to compare the 3D model of the customer's feet (1) to the subset of ISS models in the database (4) complying with these constraints and to issue a best-fit proposal naming one or more models which match with a sufficient degree both the customer's 3D foot anatomy and these additional constraints.

It is a particular idea of the invention that the generation of the ISS data (5) to be databased is done in the shoe shop using a local ISS scanner and the shoes in stock.

It is another idea of the invention to have the content of the database of ISS models be produced outside the shop by a third-party company or by manufacturers, eventually with an update on every seasonal product change or according to a given up-date calendar.

It is another idea of the invention that this database is stored in a central server and accessed via internet by the matching engine (6) located at the shoe shop.

It is another idea of the invention that the described business operates on a virtual, internet accessed on-line shop with just the foot scanner being physically available to the customer at specific locations such as malls, stores, gyms or other populated places. The customer scans its feet on such step-on scanners and receives automatically a code which defines the storage of his foot 3D data (including possible constraints (10)) for a subsequent purely on-line footwear best-fit selection and purchasing business on a virtual footwear shop. It is evident that the on-line matching engine (6) must operate with high reliability as this on-line business model does no longer include any physical try-on.

The far better matching philosophy of the current invention (matching to ISS instead of matching to digital lasts) makes this business model especially trustable, reliable and economical both for the customer and for the footwear shop owner.

1. A method of identifying footwear which best fits a customer's feet, comprising the steps of:
a) digitizing the feet of a customer needing footwear with a 3D foot scanner and generating a numerical 3D model of the customer's feet;
b) comparing, with a computer-based matching engine, the information of the 3D feet model with the content of a database containing numerical 3D models of the interior shoe shape (ISS) of footwear available to be sold;
c) producing a list of one or more best-fit footwear candidates to the customer and/or to the staff of a footwear shop to reduce the complexity, the time and the non-reliability of stock search and/or the number of footwear products to be tried on in order to come to a high-quality purchasing decision; and
d) concluding the purchasing process or, respectively, aborting it in case of insufficient best fit footwear being found in the footwear stock available for selling.

2. A method, as claimed in claim 1, wherein the matching engine receives, beyond the customer's 3D foot data generated by the foot scanner, additional footwear selection constraints from the customer via a computer interface and wherein the matching engine is programmed to compare the 3D model of the customer's feet to only the specific subset of ISS models in the database complying with these customer constraints and to issue a best-fit proposal naming one or several models which match with a sufficient degree both the customer's 3D foot anatomy and these additional constraints.

3. A method, as claimed in claim 1, wherein the matching engine receives, beyond the customer's 3D foot data generated by the foot scanner, additional footwear selection constraints from the customer via a computer interface and wherein the matching engine is programmed to use a weighted comparison of the 3D model of the customer's feet to the database containing the ISS models of available footwear while giving the specific subset of ISS models in the database complying with these customer constraints higher weights then those not complying with the constraints and to issue a weighted best-fit proposal list naming one or several footwear products in decreasing order of weighted matching.

4. A method, as claimed in claim 1, wherein the 3D foot scanner produces a multi-sensorial data set comprising both the digital geometric 3D model of the customer's feet and a sole pressure map of the customer's feet and that the matching engine compares these multi-sensorial data with the content of a database containing ISS data and foot bed data of the footwear available to be sold.

5. A method, as claimed in claim 4, wherein both data sets are in registration within a common coordinate system.

6. A method, as claimed in claim 4, wherein the matching engine compares the 3D foot data of the customer with the content of a database containing ISS data and issues a list of best-fit products and uses, in addition, the sole pressure map data for addressing a system manufacturing an individual in-lay foot bed fitting tightly in the best-fit footwear selected by the customer.

7. A method, as claimed in claim 1, wherein the data generated by the 3D foot scanner and by the matching engine are stored in a customer's file for supporting subsequent footwear buying operations.

8. A method, as claimed in claim 1, wherein the data generated by the 3D foot scanner and by the matching engine are stored in a customer's file for documenting changes in the customer's foot anatomy.

9. A method, as claimed in claim 1, wherein the matching engine matches the left and the right foot individually to ISS models stores in the database to produce a best-fitting list specific for each foot.

10. A method, as claimed in claim 1, wherein the method is practiced by a virtual, internet-based footwear buying shop containing the matching engine and the database of ISS models, the 3D foot scanner is physically located in a place commonly accessible by customers, the customers 3D foot data are, after the scanning has being performed, downloaded to the internet footwear buying shop and the customer performs his selection based on the best-fit proposals generated by the internet shop matching engine.

11. A method, as claimed in claim 2, wherein the additional footwear selection constraints include one or more of preferred price range, style, material, footwear usage, anatomic specificities such as body weight and possible left-right foot imbalance, and foot bed requirements.

12. A method, as claimed in claim 3, wherein the additional footwear selection constraints include one or more of preferred price range, style, material, footwear usage, anatomic specificities such as body weight and possible left-right foot imbalance, and foot bed requirements.
